(19) United States
(12) Patent Application Publication
(10) Pub. No.: US 2002/0034466 A1
(43) Pub. Date: Mar. 21, 2002

(54) Use of a catalyst for reducing the quantity and/or size of particles in diesel exhaust

(76) Inventors: Axel Konig, Wolfsburg (DE); Wolfgang Held, Wolfsburg (DE); Ulrich-Dieter Standt, Meine (DE); Lothar Puppe, Burscheid (DE)

Correspondence Address: William C. Gerstenzang, Norris McLaughlin & Marcus, P.A., 30th Floor, 220 East 42nd Street, New York, NY, 10017, US

(21) Appl. No.: 09/967,372

(22) Filed: Sep. 28, 2001

Related U.S. Application Data
(63) Continuation of application No. 09/548,825, filed on Apr. 13, 2000.
Application No. 09/548,825 is a continuation of application No. 08/611,699, filed on Mar. 6, 1996, now abandoned.
Application No. 08/611,699 is a continuation-in-part of application No. 08/192,874, filed on Feb. 7, 1994, now abandoned.
Application No. 08/192,874 is a continuation-in-part of application No. 07/836,043, filed on Feb. 12, 1992, now abandoned.

(30) Foreign Application Priority Data
Feb. 22, 1991 (DE) P 41 05 534.9

(51) Int. Cl. B01D 53/92

(52) U.S. Cl. 423/212; 423/213.2; 423/213.5; 60/299

(57) ABSTRACT

This invention relates to the use of a catalyst for reducing the quantity and/or size of particles in the exhaust gases of a diesel engine by means of a zeolite-containing catalyst having acidic properties.

This application is a continuation-in-part of application Ser. No. 08/192,874, filed Feb. 7, 1994, now pending; which is a continuation-in-part of application Ser. No. 07/836,043, filed on Feb. 12, 1992, now abandoned.

This invention relates to the use of a catalyst for reducing the quantity and/or size of particles in the exhaust gases of a diesel engine by means of a zeolite-containing catalyst having acidic properties.

One of the problems involved in the use of diesel engines, particularly as power plants for motor vehicles, is that diesel engines emit soot particles which are difficult to prevent from entering the environment.

A known method for preventing the soot particles from escaping is to use filters. A disadvantage of using filters is the danger of clogging by the soot particles after a relatively short operating time. Accordingly, measures have to be taken to regenerate the particle filters, for example by brief heating thereof by suitable devices to the ignition temperature of the deposited soot particles. Such devices are complicated and expensive and do not offer a technical solution for diesel-powered automobiles, for example.

It is also known that the quantity of particles can be catalytically reduced. Oxidation catalysts containing platinum as an active component are used for this purpose. A disadvantage of these noble metal catalysts is that, although they reduce the quantity of particles by oxidation of the long-chain hydrocarbons in the exhaust, they also have an oxidizing effect on the SO₂ component of the exhaust gases. The resulting formation of sulfates makes the particles hygroscopic and can even lead to an increase in the quantity of particles. In addition, sulfate particles can be expected to be deposited on the catalyst, adversely affecting its activity. Sulphuric acid is also formed, which is yet another undesirable result.

The object of the present invention therefore is to find a solution which does not have any of the described disadvantages.

It has now been found that zeolite-containing catalysts having acidic and/or cracking properties reduce the quantity and/or size of soot particles and the quantity of hydrocarbons without at the same time oxidizing the SO₂ in the exhaust gases to sulfates.

The present invention relates to the use of a catalyst for reducing the quantity and/or size of particles in the exhaust gases of a diesel engine by means of a zeolite-containing catalyst having acidic properties.

The invention is based on the realization that the quantity and size of the particles are determined to a large extent by the content of long-chain hydrocarbons i.e., those having from about 14 to about 50 carbon atoms in the structure, more particularly from about 16-30 carbon atoms in their structure, in the exhaust gases. The effect of the zeolite-containing catalyst according to the invention is that it cracks long-chain hydrocarbons present in the exhaust gases into short-chain hydrocarbons i.e., those having from about 1 to about 10 carbon atoms in this structure, more particularly from 1 to 8 carbon atoms in their structure, and oxidizes a portion of said long-chain and short-chain hydrocarbons to CO and CO₂, so that the amount of long-chain hydrocarbons is reduced, and there are less present to attach themselves to the primary soot particles. Although the end result may be a slightly higher emission of hydrocarbons (also referred to hereinafter as “HC”), this is not critical because the HC levels in diesel exhaust are low from the outset.

Accordingly, the possibility of reducing particle emissions by the described catalyst is based on a reduction in the concentration of hydrocarbons capable of attaching themselves to soot particles in the exhaust gases. These hydrocarbons are present in varying amounts, depending on the operational state of the engine, which accounts for the varying degrees of reduction in particle emissions.

The zeolite-containing catalysts used in accordance with the invention preferably have cracking properties for long-chain and aromatic hydrocarbons. They crack the long-chain and aromatic hydrocarbons in the exhaust gas stream into short-chain hydrocarbons which, although leading to a slightly higher emission of hydrocarbons, are not critical because HC levels in the exhaust gases of diesel engines are low from the outset.

Zeolites particularly suitable for use in accordance with the invention include the following structure types: faujasites, pentasils, mordenites, ZSM 12, zeolite β, zeolite L, zeolite Ω, ZSM 22, ZSM 23, ZSM 48, EU-1, etc.

The zeolite of the pentasil type preferably has an SiO₂ to Al₂O₃ ratio of 25 to 2000 and, more preferably, between 40 and 60.

Zeolites are characterized by general formula (I):

M¹_{x/n}[(M²O₂)ₓ(SiO₂)_{y}].qH₂O (I)

in which

M¹ represents one equivalent of an exchangeable cation

M² represents a trivalent element which, together with the Si, forms the oxidic framework of the zeolite,

n represents the valence of the cation M¹,

y/x represents the SiO₂ to M²O₂ ratio and ranges from 1.0 to 100, preferably from 1.0 to 50 and

q represents the number of water molecules.

In terms of their basic structure, Zeolites are crystalline alumosilicates which are made up of a network of SiO₄ and M²O₄ tetrahedrons. The individual tetrahedrons are attached to one another by oxygen bridges via the corners of the tetrahedrons and form a three-dimensional network uniformly permeated by passages and voids. The individual zeolite structures differ from one another in the arrangement and size of the pores and voids and in their composition. Exchangeable cations are incorporated to compensate the negative charge of the lattice which arises out of the M² component. The absorbed water phase qH₂O is reversibly removable without the framework losing its structure.

M² is often aluminum, although it may be partly or completely replaced by other trivalent elements.

A detailed description of zeolites can be found, for example, in the book by D. W. Breck entitled “Zeolite Molecular Sieves, Structure, Chemistry and Use”, J. Wiley & Sons, New York, 1974. A further description, particularly of high-silica zeolites suitable for catalytic applications, can be found in the book by P. A. Jacobs and J. A. Martens entitled “Synthesis of High-Silica Aluminosilicate Zeolite”, Studies in Surface Science and Catalysis, Vol. 33, Ed. B. Delmon and J. T. Yates, Elsevier, Amsterdam-Oxford-New York-Tokyo, 1987.

In the zeolites used in accordance with the invention, M² is one or more elements from the group consisting of Al, B, Ga, In, Fe, Cr, V, As and Sb and preferably one or more elements from the group consisting of Al, B, Ga and Fe.

The exchangeable cations M¹ present in the zeolites mentioned may be, for example, those of Li, Na, K, Rb, Cs, Mg, Ca, Sr, Ba and also transition metal cations, such as for example Cr, Mn, Fe, Co, Ni, Cu, Nb, Mo, Ag, Ta, W, and Re. Cations of the rare earth group and protons are also suitable.

The zeolite used in accordance with the invention preferably contains one or more of the transition elements Cu, Ni, Co, Fe, Cr, Mn and/or V, more preferably Cu, and does not require noble metals, such as platinum.

According to the invention, preferred zeolites of the structure types mentioned above are those in which some of the metal cations originally present, preferably 50 to 100% and, more preferably, 80 to 100% have been replaced by hydrogen ions.

The acidic H⁺ forms of the zeolites are preferably produced by exchanging metal ions for ammonium ions and subsequently calcining the zeolite thus exchanged. In the case of zeolites of the faujasite type, repetition of the exchange and subsequent calcination under defined conditions leads to so-called ultrastable zeolites which assume greater thermal and hydrothermal stability through this dealuminization step. Another method of obtaining high-silica zeolites of the faujasite type comprises carefully treating the anhydrous zeolite with SiCl₄ at relatively high temperatures (≧150° C.). Aluminum is removed and, at the same time, silicon is incorporated in the lattice. Treatment with ammonium hexafluorosilicate also leads under certain conditions to a high-silica faujasite.

Another method of exchanging protons in the case of zeolites having an SiO₂ to Al₂O₃ ratio of at least 5 is to carry out the process with mineral acids.

It is also known that ion exchange with trivalent rare earth metal ions—individually and/or in the form of mixtures which may advantageously be rich in lanthanum or cerium—leads to acidic centers, above all in the case of faujasite. It is also known that the exchange of transition metal cations in zeolites results in the formation of acidic centers.

The above-described zeolites containing acidic centers have the catalytic property of cracking hydrocarbons, i.e. splitting them into smaller fragments.

The results obtained with the process according to the invention using zeolitic catalysts in regard to particle conversion and hydrocarbon conversion are presented in Examples 1 to 7 below. However, the invention is not limited in any way by the examples.

The results were obtained from a 1.9 liter aspirated diesel engine under the conditions shown in the tables (rotational speed, effective average pressure as a measure of the power output, catalyst temperature). The catalyst was 102 mm in diameter and 152 mm in length.

### EXAMPLE 1

H zeolite Y, dealuminized, acidic zeolite Y with a molar SiO₂ to
Al₂O₃ ratio of 50

| | | | HC | |
|---|---|---|---|---|
| Rotational/Pme | | Temp. before | con- | Particle |
| speed | | catalyst | version | conversion |
| [1/min.] | [bar] | [° C.] | [%] | [%] |
| 2000 | 1 | 184 | 20 | 49 |
| 2000 | 4 | 357 | 21 | 28 |

### EXAMPLE 2

H zeolite Y, dealuminized, acidic zeolite Y with a molar SiO₂
to Al₂O₃ ratio of 12

| Rotational/Pme | | Temp. before | HC con- | Particle |
|---|---|---|---|---|
| speed | | catalyst | version | conversion |
| [1/min.] | [bar] | [° C.] | [%] | [%] |
| 2000 | 1 | 184 | 14 | 34 |
| 2000 | 4 | 357 | 35 | 32 |

### EXAMPLE 3

H ZSM5, acidic ZSM5, with an SiO₂ to Al₂O₃ ratio of approx. 60

| Rotational/Pme | | Temp. before | HC con- | Particle |
|---|---|---|---|---|
| speed | | catalyst | version | conversion |
| [1/min.] | [bar] | [° C.] | [%] | [%] |
| 2000 | 1 | 184 | 11 | 30 |
| 2000 | 4 | 357 | 27 | 25 |

### EXAMPLE 4

H ZSH5, acidic ZSM5, with an SiO₂ to Al₂O₃ ratio of approx. 90

| Rotational/Pme | | Temp. before | HC con- | Particle |
|---|---|---|---|---|
| speed | | catalyst | version | conversion |
| [1/min.] | [bar] | [° C.] | [%] | [%] |
| 2000 | 1 | 184 | 14 | 36 |
| 2000 | 4 | 357 | 12 | 31 |

### EXAMPLE 5

Se zeolite y, rare-earth-exchanged, acidic zeolite Y with a
ratio of SiO₂ to Al₂O₃ of 4.9 and a degree of exchange of approx.
70%

| Rotational/Pme | | Temp. before | HC con- | Particle |
|---|---|---|---|---|
| speed | | catalyst | version | conversion |
| [1/min.] | [bar] | [° C.] | [%] | [%] |
| 2000 | 1 | 187 | 17 | 37 |
| 2000 | 4 | 351 | 33 | 31 |

### EXAMPLE 6

Se zeolite y, rare-earth-exchanged, acidic zeolite Y with a
ratio of SiO₂ to Al₂O₃ of 4.9 and a degree of exchange of approx.
90%

| Rotational/Pme | | Temp. before | HC con- | Particle |
|---|---|---|---|---|
| speed | | catalyst | version | conversion |
| [1/min.] | [bar] | [° C.] | [%] | [%] |
| 2000 | 1 | 185 | 30 | 46 |
| 2000 | 4 | 356 | 26 | 30 |

### EXAMPLE 7

Cu ZSM5, Cu-exchanged, acidic ZSM5 with a ratio of SiO₂ to
Al₂O₃ of approx. 60 and a degree of exchange for Cu of approx. 70%

| Rotational/Pme | | Temp. before | HC con- | Particle |
|---|---|---|---|---|
| speed | | catalyst | version | conversion |
| [1/min.] | [bar] | [° C.] | [%] | [%] |
| 2000 | 1 | 153 | 31.8 | 37.4 |
| 2000 | 4 | 307 | 25.0 | 38.7 |

It will be understood that the specification and examples are illustrative but not limitative of the present invention and that other embodiments within the spirit and scope of the invention will suggest themselves to those skilled in the art.

1. In a method of treating exhaust gases from a diesel engine which emits an exhaust gas containing particles of soot and hydrocarbons, the improvement which comprises contacting the exhaust gas with a catalyst consisting essentially of a zeolite having acid properties, and of the general formula
M¹_{x/n}[(M²O₂)ₓ(SiO₂)_{y}].qH₂O (I)
in which
M¹ represents one equivalent of an exchangeable cation
M² represents a trivalent element which, together with the Si, forms the oxidic framework of the zeolite,
n represents the valence of the cation M¹,
y/x represents the SiO₂ to M²O₂ ratio and ranges from 1.0 to 100, preferably from 1.0 to 50 and
q represents the number of water molecules.
wherein 50-100% of said metal cations M¹ have been replaced by hydrogen ions, whereby the hydrocarbons are cracked, with partial oxidation, and at least one of the size or the quantity of the soot particles is reduced, and SO₂, if contained in said exhaust gas, is not oxidized.

2. The method according to claim 1, wherein the zeolite has cracking properties for long-chain and aromatic hydrocarbons.

3. The method according to claim 1, wherein the zeolite is a faujasite.

4. The method according to claim 1, wherein the zeolite is a dealuminized faujasite.

5. The method according to claim 1, wherein the zeolite is a pentasil.

6. The method according to claim 5, wherein the zeolite has SiO₂ and Al₂O₃ at an SiO₂ to Al₂O₃ ratio of 25 to 2000.

7. The method according to claim 1, wherein the zeolite is a mordenite.

8. The method according to claim 1, wherein the zeolite is a dealuminized mordenite.

9. The method according to claim 1, wherein the zeolite contains at least one element selected frog the group consisting of elements of the 2nd main group of the periodic system of elements and the rare earth elements.

10. The method according to claim 1, wherein the zeolite contains at least one transition element.

11. The method according to claim 1, wherein the zeolite contains at least one element selected from the group consisting of Cu, Ni, Co, Fe, Cr, Mn and V.

12. The method according to claim 1, wherein the zeolite contains Cu.

13. In combination, a diesel engine, a pipe for exhaust gas produced when operating the diesel engine, and a zeolite having acidic properties positioned so that the exhaust gas contacts it in exhausting to the atmosphere.
